(19) United States
(12) Patent Application Publication
(10) Pub. No.: US 2007/0174152 A1
(43) Pub. Date: Jul. 26, 2007

(54) Handheld system for information acquisition, verification, recording, processing, display and communication

(76) Inventors: David B. Bjornberg, Windber, PA (US); John Tad Britt, Champaign, IL (US)

Correspondence Address: HUMPHREYS ENGINEER CENTER SUPPORT ACTIVITY;ATTN: CEHEC-OC, 7701 TELEGRAPH ROAD, ALEXANDRIA, VA, 22315-3860, US

(21) Appl. No.: 11/727,636

(22) Filed: Mar. 27, 2007

Related U.S. Application Data
(63) Continuation-in-part of application No. 10/729,269, filed on Dec. 8, 2003.

(51) Int. Cl. G06Q 10/00

(52) U.S. Cl. 705/28

(57) ABSTRACT

A portable system and method that automates collection, integration, analysis, reporting and archiving of data and collection and archiving of specimens in a variety of applications while insuring chain of custody integrity not attainable conventionally. Applications include: forensics, municipal management, utility management, real estate, insurance, environmental protection and remediation, safety, security, education, emergency management, land use, fish and wildlife management, construction and maintenance of highways and waterways, mining, timber, agricultural, resource exploration, manufacturing, recreational management, urban restoration, military, and archaeological preservation. Select embodiments integrate a number of functions in a handheld device, employing digital technology, integrated sensors, marking, tracking and monitoring tags, and specialized software as well as processors for analysis, such as CPUs, ASICs, PCs and the like. Select embodiments are useful to increase efficiency and reduce cost for post-processing and real-time data and specimen collection, reporting, analysis, and facilitate pro-active direction of ongoing field studies.

### RELATED INVENTIONS

Under 35 U.S.C § 121, this application is a continuation-in-part of, and claims the benefit of, prior co-pending U.S. patent application Ser. No. 10/729,269, Automated Resource Management System (ARMS™), by Britt, filed Dec. 8, 2003, published Jul. 8, 2004, publication number 2004/0133347, and incorporated herein by reference.

### STATEMENT OF GOVERNMENT INTEREST

Under paragraph 1(a) of Executive Order 10096, the conditions under which this invention was made entitle the Government of the United States, as represented by the Secretary of the Army, to the entire right, title and interest therein of any patent granted thereon by the United States. This patent and related ones are available for licensing. Contact Bea Shahin at 217 373-7234.

### BACKGROUND

The United States has enacted a variety of environmental and cultural preservation laws, e.g., the National Environmental Protection Act (NEPA), the National Historic Preservation Act (NHPA), and the Clean Water Act (CWA). Further, complex investigations are mandated from this legislation, such as Environmental Site Assessments (ESA) and Environmental Impact Statements (EIS), as well as various state, local, and tribal requirements.

Compliance with these often requires one to inventory, manage, and conserve both natural and cultural resources. The competing needs of environmental sustainability and efficient land use often require implementation of complex, integrated programs to reconcile the two. Central to this issue is the need to collect, inventory, and process field data and maintain accurate and consistent records. Conventional methods for doing this are expensive and inefficient, in large part due to manual operations involved. Further, operational exigencies often lead to important information being missed or recorded improperly. Factors such as the training and experience of personnel, inconsistent data collection practices, and inherent opportunity for error in manually taking data adversely affect the quality of the final product.

Commercial off-the-shelf (COTS) tools available for environmental and cultural resources data collection are typically single-purpose units with limited, if any, ability to integrate with complementary units. With increased emphasis to implement and maintain sustainable environmental practices and protect our cultural heritage, innovative technologies and applications are needed. A solution is provided in a capability provided by the Automated Resource Management System™ (ARMS™) of the parent application incorporated herein by reference. ARMS™ automates data collection and integrates information to facilitate inventorying, analysis, reporting and archiving.

Further advantages of the present invention will be apparent from the description below with reference to the accompanying drawings, in which like numbers indicate like elements.

### BRIEF DESCRIPTION OF THE DRAWINGS

FIG. 1 is a block diagram describing the general classes of elements used in implementing an embodiment of the present invention.

FIG. 2 is a side view of an embodiment of the present invention as may be implemented in a single housing.

FIG. 3 is a top view of the embodiment of FIG. 2.

FIG. 4 is a perspective of a typical RFID as may be used with an embodiment of the present invention.

FIG. 5 is an end view of the embodiment of FIG. 2 as seen from the front.

### DETAILED DESCRIPTION

Select embodiments of the present invention provide in a robust compact handheld unit a decision-facilitating tool that allows a user to collect, display and analyze data such as geospatial, metric, and feature attribute data associated with a mobile geographical information system (GIS). In select embodiments of the present invention a resource (asset) management tool remotely and securely captures and displays aspect information, e.g. stand-off position data. In select embodiments of the present invention data may be transferred immediately, e.g., via wireless means, to other parties.

In select embodiments of the present invention, the decision-enabling process is accomplished by a criteria-driven customized application specific to needs of the user. In select embodiments of the present invention the data capture application establishes an encrypted “chain-of-custody” for collected data. In select embodiments of the present invention condition indices (CIs) may be generated and remedial actions taken in the field. In select embodiments of the present invention built-in telecommunications modules allow a user to transmit data real-time to others, e.g., to share in decision making. Select embodiments of the present invention are able to operate a minimum of twelve (12) hours on COTS rechargeable batteries.

Select embodiments of the present invention employ modular components enabled via “plug and play” interfaces. This allows a user to select and configure hardware components and pre-load software applications to tailor the embodiment to the task, e.g., specific types and level of engineering investigations such as weapons' detection, route reconnaissance, bridge reconnaissance, environmental baseline surveys and the like. Data such as baseline project information and GIS coverage may be pre-loaded prior to going to the field. For example, survey transects and sample plot coordinates are useful for ensuring accuracy and efficiency and reducing unanticipated delays in civil engineering tasks.

In select embodiments of the present invention customizable function buttons allow users to collect multiple types of data simultaneously. For example, a digital photo may be recorded at the same time as the tilt angle and position coordinates of the camera, camera settings, date and time, camera operator's name, and like data are captured. In select embodiments of the present invention the data processing may be done by personal computers (PCs) loaded with appropriate mission databases and physically integrated into the unit itself. In select embodiments of the present invention, the databases may be populated automatically upon selection of a pre-specified mission or from hardware connectable to expansion ports on the onboard PC via a single trigger action.

In select embodiments of the present invention, the modules comprising the embodiment are equipped with seals that are water and air tight in accordance with user requirements, e.g., MILCON-STD-810 for military applications; or IP67 for commercial applications. Further, in select embodiments of the present invention all connections have a locking mechanism so that critical connections to power, data input and modular components are not terminated inadvertently.

A select embodiment of the present invention provides a portable integrated configuration for supporting activities at remote locations, such activities to include but not be limited to collecting, preserving, integrating, processing and communicating information and collecting and transporting specimens. These embodiments comprise: a central processing unit (CPU) having at least some of the capabilities of a personal computer to include one or more displays; one or more input/output (I/O) devices (e.g., a mouse, a keyboard, a touch screen and the like); instrumentation that may communicate directly with the CPU, other instrumentation, or both; hardware interfaces that may be employed between the instrumentation and the CPU and between two or more items of instrumentation; software interfaces that may be employed between the instrumentation and the CPU and between two or more items of instrumentation; one or more Global Information Systems (GIS) in operable communication with the CPU for providing geo-spatially referenced attribute data that expedites the resolution of spatial relationships; and a communications system to facilitate operation among the portable integrated configuration, the instrumentation and one or more off-site locations, and the like.

In select embodiments of the present invention communications may be provided by: Wi-Fi-enabled systems, laptop computers, cellular communications, satellite communications, two-way radios, Personal Digital Assistants (PDAs), cameras, wireless communication devices, land lines, encryption devices, fiber optic wireless devices, infrared wireless devices, RF wireless devices, digital radios operating on a WPAN, combinations thereof, and the like.

ZIGBEE™, a specification for a suite of high level communication protocols using small, low-power digital radios based on the IEEE 802.15.4 standard for wireless personal area networks (WPANs) may be used in an embodiment of the present invention. The relationship between IEEE 802.15.4-2003 and ZIGBEE™ is similar to that between IEEE 802.11 and the Wi-Fi Alliance.

Select embodiments of the present invention may incorporate one or more devices to provide coded labels, such as a one or two-dimensional barcode reader, including hybrid (barcode plus RFID) readers, which may be controlled by the CPU to facilitate inventorying and tracking of collected specimens. In select embodiments of the present invention, passive and sensor-enabled active, radio frequency identification devices (RFID) and hybrid barcode plus RFID tags may be also used to tag, track and monitor phenomena. Active RFID tags with built in sensors, can be coupled with the geo-spatial awareness technology in order to create a geo-spatially planted RFID detection sensor. Using this technique with multiple RFID tags will allow for a geo-referenced array of remote detection sensors (a geospatial sensor network) that can be rapidly scanned and interpreted from a significant stand-off distance.

In select embodiments of the present invention the instrumentation may be any of: cameras, digital cameras with video and audio capabilities, sensors, instruments, optical scanners, analog-to-digital (A/D) converters, timers, clocks, inclinometers, inertial monitoring units, altimeters, thermometers, barometers, compasses, differential global positioning systems (GPS), indoor global positioning systems, laser range finders, radars, LADARs, sonar devices, spectrometers, digital signal processors (DSPs), combinations thereof, and the like.

In select embodiments of the present invention the information able to be processed may be from sources such as: specialized data entry forms, aerial photographs, mapping programs, Geographic Information System (GIS) data, GIS data compliant with Federal Geographic Data Committee (FGDC) and Spatial Data Standard for Facilities, Infrastructure, and Environment (SDSFIE) standards, GPS data to include DGPS data, manually entered data, video data, audio data, analog data, digital data, combinations thereof, and the like. In select embodiments of the present invention, a unit may be configured for real-time kinematic survey (RTK).

In select embodiments of the present invention the CPU may be any of: a laptop computer, a personal computer, a PDA, a purpose-built data collection device, an application specific integrated circuit (ASIC), combinations thereof, and the like.

Select embodiments of the present invention may be handheld in one hand to enable operation thereof by the other hand. In select embodiments of the present invention, options may include a tripod or cradled vehicle mount, and the like suitable for use in a variety of applications. Select embodiments of the present invention may incorporate ports to facilitate connection to external devices. Select embodiments of the present invention may incorporate antennas to facilitate communication with external devices. Select embodiments of the present invention may incorporate a touch screen as a display.

Select embodiments of the present invention provide a method employing a handheld portable device for facilitating the collection of data and specimens, managing the cataloguing and transportation of specimens, for preserving, integrating, processing and communicating information at and from remote locations, and the like, using a variety of sources. The method comprises: providing the portable device; establishing requirements for managing field collection activities including collection of both information and specimens and for preserving, integrating, processing and communicating of data; selecting a mix of hardware and software to incorporate in the portable device to meet user requirements; procuring the hardware and software; and integrating the hardware and software to implement the method for a specific mission.

In select embodiments of the present invention, the method facilitates collection of specimens by identifying the specimens by a code, a date/time stamp associated with the code, and by a collection geospatial position associated with the code. In select embodiments of the present invention, the method provides for time tagging the collected information. In select embodiments of the present invention, the method merges location data with the collected information about the feature, event, or both, providing some or all of the location data from GPS data from one or more GPS receivers, from RFID tags, and the like.

In select embodiments of the present invention, integration of the hardware and software is facilitated by commercial-off-the-shelf (COTS) software. In select embodiments of the present invention, interactive databases are part of the provided software. In select embodiments of the present invention, the software incorporates one or more Geographic Information Systems (GIS).

In select embodiments of the present invention two or more discrete pieces of information are integrated via the execution of a single step that may include any of: clicking a mouse, pushing a button, activating a switch, entering a command into a computer, touching a video screen, initiating a voice command, activating a tone, employing a source of electromagnetic energy, and combinations of the above. In select embodiments of the present invention, included with discrete pieces of information are data on location of collection of the information and the time of collection thereof.

In select embodiments of the present invention, specific components and software may include:
A small portable computer such as one that may incorporate:
   an operating system such as WINDOWS XP®,
   a hard drive, e.g., an internal hard drive of 80 GB capacity,
   an integrated capability for interfacing with RTK-enabled, differential global positioning systems (GPS) (such as GALILEO®, GLOSSNASS, WAAS, EGNOS)
   a package that may include a mix of COTS components and software together with custom middleware, hardware and software packages, and the like;
Hands-free communications device also suitable for voice recording that may include:
   small digital radios operating on a Wireless Personal Area Network (WPAN) using ZIGBEE™,
   WiFi (Bluetooth) capability,
   IEEE protocol 801.11g,
   secure telecommunications,
   mesh networking,
   satellite phone,
   cellular phone,
   and the like;
Power source(s) that may include any of:
   power supply(ies) such as may be suitable for a laptop computer's keyboard and monitor as well as for integrating other devices (e.g., measurement devices to take geophysical, chemical, environmental metrics, particulate sizes, and the like),
   various chargers such as a solar charger, a fuel cell (such as may be capable of 60 hours uninterrupted battery life) and the like,
   rechargeable batteries, in particular those suitable for powering video equipment; adapters for chargers operating at low voltage, e.g., 12 and 24-volt systems and up to 48 volts in global use);
   vehicle mount suitable for charging and viewing large displays;
Digital camera(s) (operating at pre-specified wavelengths (visual, IR) and resolution, with digital and optical zoom and the like, incorporating any of:
   image stabilization (also known as vibration reduction and other proprietary manufacturer's names),
   image buffering;
   SMPTE Hybrid Elimination Device (SHED) (for high definition requirements); and, a monitor;
Data scope that may display input from any (including integrated versions) of:
   a scientific calculator,
   a rangefinder such as a laser distance measurer (LDM);
   an inertial navigation unit;
   an auto declination capability;
   an atomic clock (synchronized);
   automatic time zone setting;
   an Inertial Navigation System (INS) for indoor mapping;
   an encrypted “chain-of-custody” capability for all data metadata; a compass,
   a chronometer with stopwatch function,
   devices (including integrated versions and “plug 'n play” sensor modules) providing metrics such as:
      temperature,
      pressure;
      altitude,
      inclination,
      vertical height,
      sound,
      photosynthetic energy (e.g., quantum meter),
      vegetation vitality (e.g., shigometer),
      water temperature,
      wind,
      fluid flow,
      light,
      soil moisture,
      pH,
      oxygen content, such as BOD or COD indicators,
      salinity,
      turbidity,
      color,
      electrical resistance and conductivity (Ohm meter),
      depth,
      and the like;
   Data logger;
   Sensors (some of which may be integral or available as modules), to include:
      thermal (e.g., infrared sensor(s),
      proximity,
      sniffing sensor(s) (e.g., such as may sample air quality),
      particulate sensor(s),
      ultrasonic sensor(s),
      piezoelectric sensor(s),
      seismic sensor(s),
      environmental sensor(s) (e.g., hygrometers),
      and the like.
   Analyzers (some of which may be integral or available as modules) such as an X-Ray fluorescence (XRF) device;
   Night vision headset to include wireless-enabled devices and Bluetooth®-enabled Vector™ binoculars,
   Hybrid and conventional barcode labeler and reader, to include wireless-enabled devices;
   Radio frequency identification (RFID) systems (some of which may be integral or available as modules, to include wireless-enabled read/write, passive and active devices);
   Marking systems (some of which may be integral or available as modules), to include any of:
      micro-wire marking and tracking system (to include wireless-enabled devices),
      bar code printer,
      active RFID devices,
      aerosol paint dispenser(s); and
   Connections (to include those incorporated in modular devices for use with a basic unit), to include any of:
      ports for robust circular push-pull connectors (e.g., LEMO®);
      ports for standard connectors in the electronics industry (e.g., USB and RS-232 serial cables),
      Real-Time Kinematic (RTK)-capable external GPS antenna connections, and the like.

### EXAMPLE

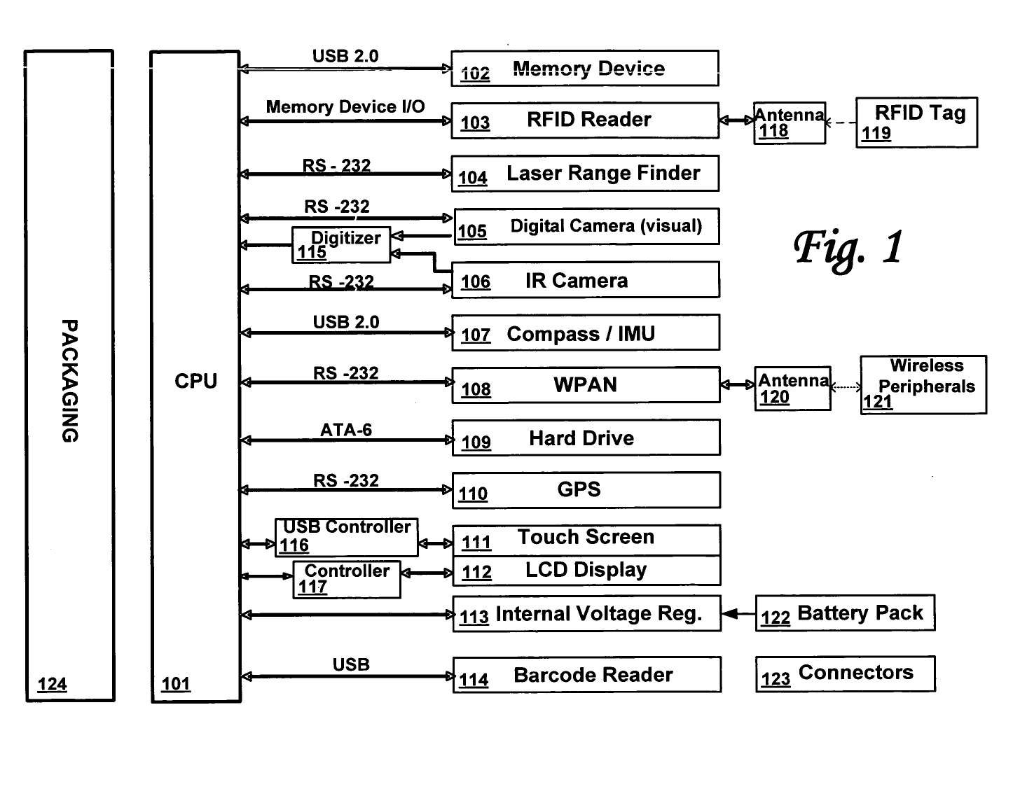

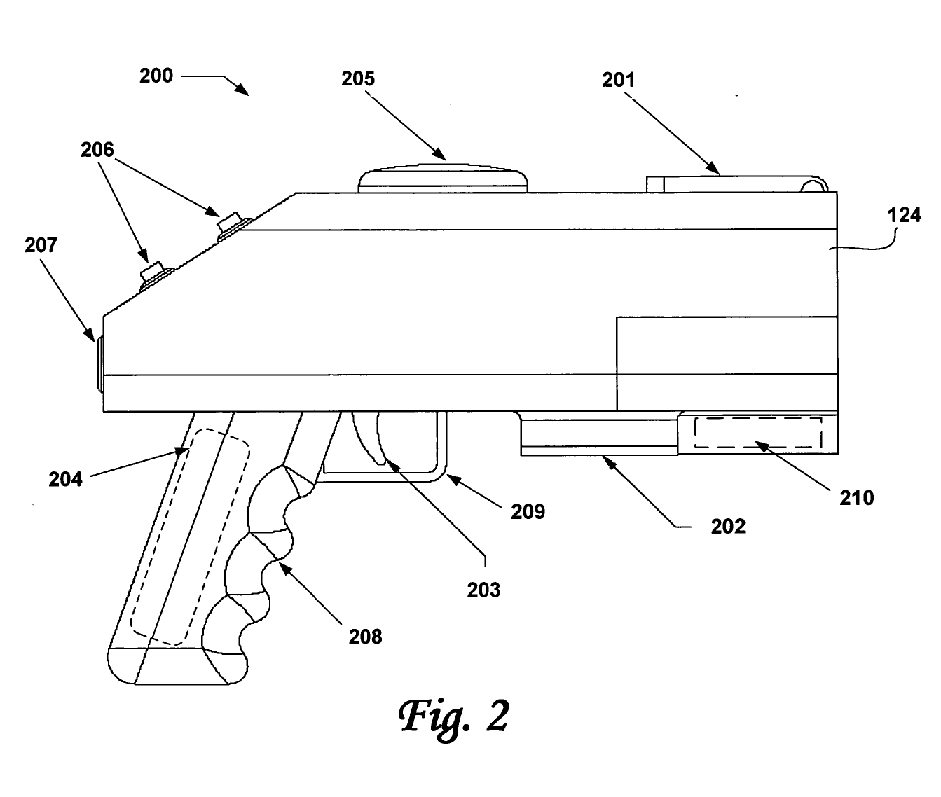

Refer to FIG. 1. Select embodiments of the present invention, such as the Hand-Held Apparatus For Mobile Mapping And Expedited Reporting (HAMMER™) 200 (FIG. 2), may comprise a central processing unit (CPU) 101, such as may be used in a laptop computer, contained within packaging (e.g., a case) 124 that is portable and may be configured for handheld operation. Various devices may be installed (or configured as “plug n'play” modules for installation) within the packaging 124 to be in operable communication with the CPU 101. These include one or more memory devices 102 that may use USB 2.0 interconnections; an RFID reader 103 that may use memory device I/Os for communication with the CPU 102 and a related antenna 118 for communication with one or more RFID tags 119; a laser range finder 104 that may use an RS-232 cable for communication with the CPU 101; both digital visible spectrum 105 and IR 106 cameras that may employ a digitizer or RS-232 cables to communicate with the CPU 101; a compass/IMU 107 that may use USB 2.0 interconnections to the CPU 101; a wireless personal area network (WPAN) communications device 108, such as a digital radio, that may use an RS-232 cable for communication with the CPU 101 with associated antenna 120 for communication with wireless peripherals 121; a hard drive 109 communicating with the CPU 101 via an interface such as one employing the Advanced Technology Attachment specification, ATA-6; a Global Positioning System (GPS) transceiver 110 communicating over an RS-232 cable with the CPU 101; a touch screen 111 communicating with the CPU 101 using a USB controller 116; an LCD display 112 communicating with the CPU 101 via a controller 117; an internal voltage regulator 113 between a battery pack 122 and the CPU 101; and a barcode reader 114 communicating with the CPU via a USB cable. In addition, various connectors 123, ports and hardwires are needed to provide access to other peripherals such as printers, PDAs, recorders, instrumentation, simulators, sensors and the like (all not shown separately for clarity).

Refer to FIG. 2, a profile of one handheld embodiment 200 of the present invention. The case 124 incorporates a hollow pistol grip 208 to support it single-handedly, leaving one hand free to operate controls such as the trigger 203 and function buttons 206. A power button 207 is provided on the back of the case 200 for conserving batteries in a battery pack 204 located in the pistol grip 208. To prevent accidental operation of the trigger 203, a trigger guard 209 and safety (not shown separately) is provided. A GPS receiver 205 is located on top to optimize reception from satellites. In select embodiments of the present invention a retractable high gain RFID antenna (not shown separately) is located in a covered slot 201 in the top to augment an internal short-range RFID antenna (not shown separately). To further stabilize the case 124 a tripod mount 202 (tripod not shown separately) is provided for such operations as photo taking as may be initiated via the trigger 203. In addition, a bay 210 for optional sensor(s) is provided in the bottom front of the case 124.

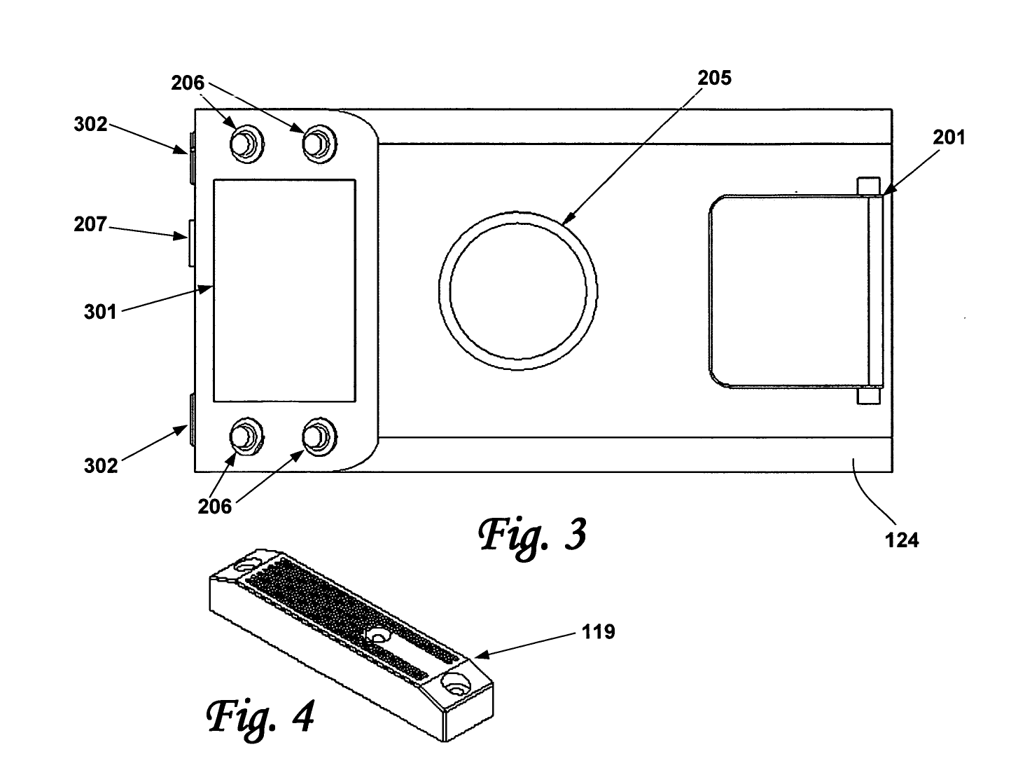

Refer to FIG. 3, a top view of the embodiment 200 of FIG. 2. At the viewer's left side (rear of the case 124) is a display 301, such as a liquid crystal display (LCD), and ports 302, e.g., a port for a robust LEMO connector. The “programmable buttons” 206 may be used to select the function that the trigger 203 activates. For example, the trigger 203 may be used to activate a digital camera (visible or IR), a sensor, an RFID tracking function, an external recorder (via a suitable port 302), a laser range finder, a barcode reader, thermal imager, RF communications, and the like. The ports may be suitable for use with external RF devices, power input/output, chargers, USB 2.0 video input/output, a keyboard, a joystick, a mouse, SD memory, and the like. FIG. 4 is a perspective view of an active RFID tag 119 that may be used with an embodiment of the present invention for marking, tracking, data logging, and the like.

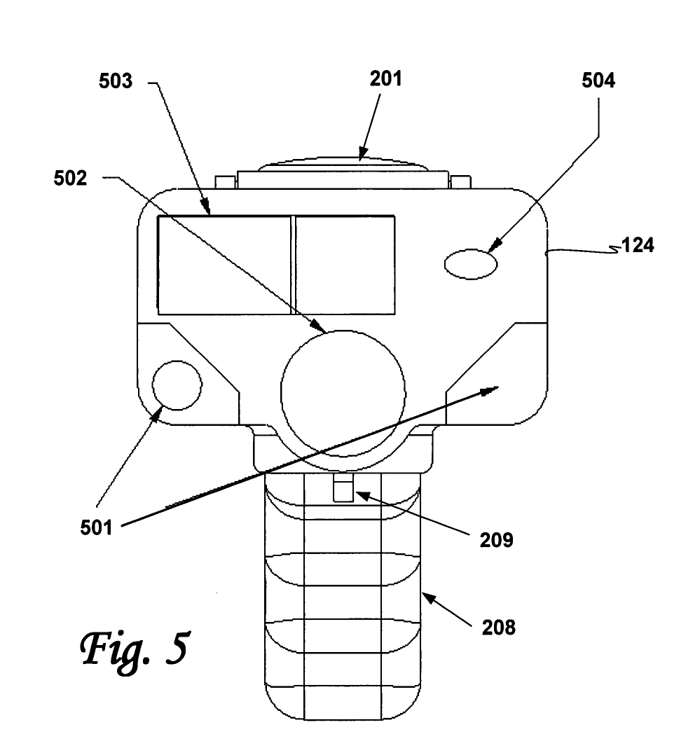

Refer to FIG. 5, an end view of the front of the embodiment 200 of FIG. 2. Sensor bays 501 are included in the case 124 to allow mounting of sensors appropriate to the mission, such as thermal imagers, inclinometers, altimeters, and the like. In select embodiments of the present invention, a digital camera 502 is incorporated for collecting date-time stamped photographic specimens at appropriate resolution and wavelength. A laser range finder 503 may be incorporated in select embodiments of the present invention as appropriate to the mission. Further, a one or two-dimensional barcode reader 504 may be incorporated in select embodiments of the present invention to support a mission requiring specimen collection, for example.

While the invention has been described in terms of some of its embodiments, those skilled in the art will recognize that the invention can be practiced with modifications within the spirit and scope of the appended claims. For example, although the system is described in specific examples for a handheld device, it will operate in any number of configurations including in a backpack or lumbar pack, suitcase, mounted on a tripod, fixed site, mounted in a robot, mounted in an unmanned aerial vehicle, mounted in an unmanned ground vehicle, and the like, for applications including archeological investigations, forensics, intelligence gathering, geophysical exploration and users with military, industrial, commercial, recreational, mining, and agricultural applications, and the like. Thus, it is intended that all matter contained in the foregoing description or shown in the accompanying drawings shall be interpreted as illustrative rather than limiting, and the invention should be defined only in accordance with the following claims and their equivalents.

The abstract of the disclosure is provided to comply with the rules requiring an abstract that will allow a searcher to quickly ascertain the subject matter of the technical disclosure of any patent issued from this disclosure. 37 CFR §1.72(b). Any advantages and benefits described may not apply to all embodiments of the invention.

We claim:

1. A portable integrated configuration for supporting activities at remote locations, said activities to include but not be limited to collecting, preserving, integrating, processing and communicating information and collecting, marking, tracking, and transporting specimens, comprising:
a central processing unit (CPU) having at least some of the capabilities of a personal computer;
instrumentation,
wherein said instrumentation may communicate directly with said CPU, other instrumentation, or both;
hardware interfaces,
wherein said hardware interfaces may be employed between said instrumentation and said CPU and between two or more items of said instrumentation;
software interfaces,
wherein said software interfaces may be employed between said instrumentation and said CPU and between two or more items of said instrumentation;
at least one Global Positioning System (GPS) device integrated with a Global Information System (GIS) in operable communication with at least said CPU,
wherein said combination of said GPS device and a GIS provides geo-spatially referenced attribute data that expedites the resolution of spatial relationships;
means for communications,
wherein said means for communications facilitate operation among said portable integrated configuration, at least said instrumentation and at least one off-site location;
at least one input/output device; and
at least one display.

2. The configuration of claim 1 in which said means for communications are selected from the group consisting of: Wi-Fi-enabled systems, laptop computers, cellular communications devices, satellite communications devices, two-way radios, Personal Digital Assistants (PDAs), cameras, wireless communication devices, land lines, encryption devices, fiber optic wireless devices, infrared wireless devices, RF wireless devices, digital radios operating on a WPAN, and combinations thereof.

3. The configuration of claim 1 further comprising at least one device to provide coded labels, said device in operable communication with said CPU, wherein said device to provide coded labels facilitates inventorying and tracking of said specimens.

4. The configuration of claim 3 in which said device to provide coded labels is a barcode reader.

5. The configuration of claim 4 in which said barcode reader is a two-dimensional barcode reader.

6. The configuration of claim 4 in which said barcode reader is a hybrid (barcode plus RFID) reader.

7. The configuration of claim 1 in which said instrumentation is selected from the group consisting of: cameras, digital cameras with video and audio capabilities, sensors, instruments, optical scanners, analog-to-digital (A/D) converters, timers, clocks, inclinometers, altimeters, thermometers, barometers, inertial monitoring units, compasses, differential global positioning systems (GPS), indoor global positioning systems, laser range finders, radars, LADARs, sonar devices, spectrometers, digital signal processors (DSPs) and combinations thereof.

8. The configuration of claim 1 further comprising employing said information selected from the group of sources consisting of: specialized data entry forms, aerial photographs, mapping programs, Geographic Information System (GIS) data, GIS data compliant with Federal Geographic Data Committee (FGDC) and Spatial Data Standard for Facilities, Infrastructure, and Environment (SDSFIE) standards, GPS data, manually entered data, video data, audio data, analog data, digital data, and combinations thereof.

9. The configuration of claim 1 in which said CPU is selected from the group consisting of: laptop computers, personal computers, PDAs, purpose-built data collection devices, application specific integrated circuits (ASICs), and combinations thereof.

10. The configuration of claim 1 in which said configuration may be handheld in one hand to enable operation thereof by the other hand.

11. The configuration of claim 1 further comprising ports to facilitate connection to external devices.

12. The configuration of claim 1 further comprising antennas to facilitate communication with external devices.

13. The configuration of claim 1 incorporating a touch screen in said display.

14. A method employing a handheld portable device for facilitating the collection of data and specimens, managing the cataloguing and transportation of specimens, and for preserving, integrating, processing and communicating information at and from remote locations using a variety of sources, comprising:
providing said portable device;
establishing requirements for said managing, preserving, integrating, processing and communicating information;
selecting a mix of hardware and software to incorporate in said portable device to meet said requirements;
procuring said hardware and software; and
integrating said hardware and software to implement said method.

15. The method of claim 14 further facilitating collection of specimens by identifying said specimens by a code, a date/time stamp associated with said code, and by a collection location associated with said code.

16. The method of claim 14 further comprising time tagging said information.

17. The method of claim 14 further comprising merging location data with said information.

18. The method of claim 17 providing said location data at least in part from GPS data from at least one GPS receiver.

19. The method of claim 14 performing said integrating at least in part using commercial-off-the-shelf (COTS) software.

20. The method of claim 14 employing interactive databases as part of said software.

21. The method of claim 14 incorporating said software as at least one Geographic Information System (GIS).

22. The method of claim 14. integrating at least two discrete pieces of said information via the execution of a single step.

23. The method of claim 22 selecting said single step from the group consisting of: clicking a mouse, pushing a button, activating a switch, entering a command into a computer, touching a video screen, a voice command, activating a tone, employing a source of electromagnetic energy, and combinations of the above.

24. The method of claim 22 including as said discrete pieces of information at least data on location of collection of said information and time of collection of said information.
